(19) United States
(12) Patent Application Publication
(10) Pub. No.: US 2025/0336146 A1
(43) Pub. Date: Oct. 30, 2025

(54) DETERMINING LIGHTING AND COMPOSITION PARAMETERS USING MACHINE LEARNING MODELS FOR SYNTHETIC DATA GENERATION

(71) Applicant: Nvidia Corporation, Santa Clara, CA (US)

(72) Inventors: Zian Wang, Toronto (CA); David Jesus Acuna Marrero, Toronto (CA); Sanja Fiddler, Toronto (CA); Zan Gojcic, Zurich (CH); Ruofan Liang, Toronto (CA); Nicolas Sharp, Seattle, WA (US); Merlin Nimier-David, Vaud (CH)

(21) Appl. No.: 18/646,048

(22) Filed: Apr. 25, 2024

(51) Int. Cl. G06T 15/50; G06T 15/60

(52) U.S. Cl. CPC G06T 15/506; G06T 15/60; G06T 2200/04

(57) ABSTRACT

Approaches presented herein provide for the determination of realistic lighting parameters for a scene represented in an image. Realistic lighting parameters can allow for the insertion of one or more virtual objects into a scene image, where the lighting or shading applied to the virtual object(s) can be consistent with those for other objects in the scene. A machine learning model such as a discriminator or diffusion model can be used to analyze a composed image generated by a differential renderer, for example, in which at least one virtual object has been inserted into a scene image and had lighting effects applied in accordance with a set of lighting parameters. A loss value can be determined based on the results of this machine learning model, which can be used to optimize the lighting parameters and/or adjust the weights or parameters of a model used to generate the lighting parameters. Once fine-tuned or optimized, the lighting parameters can represent an accurate light map for the scene or environment that can be used to generate composed images.

### BACKGROUND

In various applications—such as for gaming, animation, or virtual reality content generation, for example—it can be beneficial, if not a requirement, to render complex three-dimensional objects in a way that appears substantially realistic, or at least consistent, to a human viewer. Machine learning has improved the ability to generate composite images, including the insertion of virtual objects into an input image. In order to faithfully perform virtual object insertion, however, the environmental lighting conditions of the scene need to be estimated to allow for realistic shadows and lightning effects to be applied to the object that appear consistent with other lighting in the scene. Estimating the lighting of a scene from a single image, or even a limited set of images, can be difficult, however, such that prior approaches typically relied upon the use of priors to guide the estimation. These priors were often handcrafted heuristic priors that are difficult hard to generalize across scenes. For certain prior approaches where the scenes correspond to physical environments, a special capture device can be used to capture lighting information, but such lighting information will often not be available. In other prior approaches a human artist can attempt to manually position virtual lighting in a way that appears to be consistent for a scene, but such an approach can be expensive and time consuming, and may lead to inconsistent lighting when generated using only the lighting visible from a single image or single view of a scene.

### BRIEF DESCRIPTION OF THE DRAWINGS

Various embodiments in accordance with the present disclosure will be described with reference to the drawings, in which:

FIGS. 1A-1E illustrate example images and image masks at different stages of image composition, according to at least one embodiment;

FIG. 2 illustrates components of a first example system that can be used to optimize and/or learn lighting parameters for a scene to be represented in a composed image, according to at least one embodiment;

FIG. 3 illustrates components of a second example system that can be used to optimize lighting parameters for a scene to be represented in a composed image, according to at least one embodiment;

FIGS. 4A and 4B illustrate components of an example content generation system, according to at least one embodiment;

FIGS. 5A and 5B illustrate example processes for rendering composite images using lighting parameters that are optimized or otherwise learned for a particular scene, according to at least one embodiment;

FIG. 6 illustrates components of a distributed system that can be utilized to generate and provide image content, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI with large language models (LLMs) and/or vision language models (VLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs and/or VLMs, systems for performing light transport simulation, systems for performing collaborative content creation for 3D assets, systems implemented at least partially using cloud computing resources, and/or other types of systems.

Approaches in accordance with various illustrative embodiments provide for the generation of digital content, such as high quality image or video data. In particular, various embodiments provide for insertion of one or more virtual objects into an image of a scene (or environment, etc.), where inserted virtual objects are to have lighting effects applied that are consistent and/or realistic for the scene depicted in the image. A machine learning model, such as a diffusion model or discriminator, can act as a guide when estimating an environmental light map (or other lighting representation) for the scene, which can then be used to light the virtual object, as well as estimating other aspects such as the material properties of the object and parameters of the virtual camera, etc. In at least one embodiment, one or more virtual objects are inserted at one or more locations in the scene, such as by using a differentiable renderer or generative neural network, to generate one or more synthetic images. A set of initial default lighting parameters can be used to light and/or shade the virtual objects inserted into in the scene as represented in the synthetic image(s). The synthetic (or composed) image(s) (including the objects represented according to the lighting parameters) can be provided to a machine learning model, such as a discriminator or diffusion model, and an attempt made to determine a loss value for each synthetic image. For a discriminator, the loss can be a function of the determined realism of a composite image, while for a diffusion model the loss can be based on a comparison of the composite image versus a denoised image produced by the trained diffusion model, among other such options. The loss values can be used to adjust the lighting parameters (or adjust weights of a network to infer the lighting parameters), and one or more updated synthetic images can be differentiably rendered using the updated lighting parameters with respect to the inserted virtual object(s). The process can continue until an acceptable environmental map or other such lighting representation is determined for the scene, such as when a perceptual realism criterion has been met or satisfied. The resulting set of lighting parameters can then be used for rendering images of that scene from various viewpoints and with various objects inserted at various locations.

Variations of this and other such functionality can be used as well within the scope of the various embodiments as would be apparent to one of ordinary skill in the art in light of the teachings and suggestions contained herein.

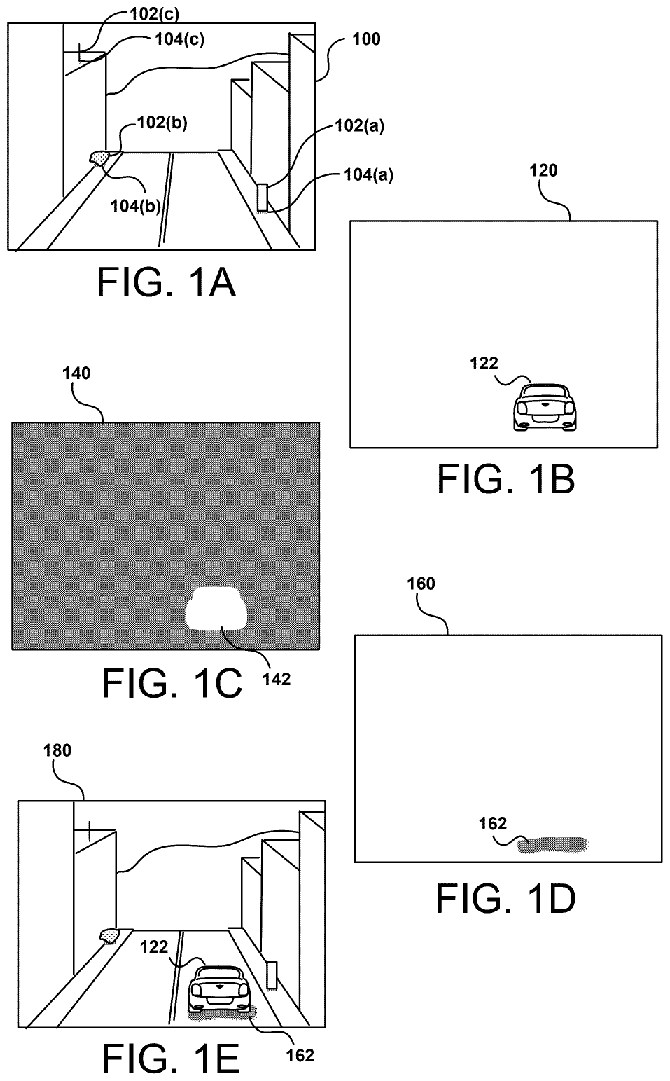

FIGS. 1A through 1E illustrate stages of an example approach to generating a composite image that can be performed in accordance with at least one embodiment. In this example, an input scene image 100 can be obtained as illustrated in FIG. 1A that illustrates a set of objects—such as one or more foreground and background objects—that are located in an environment. The input scene image 100 may correspond to an image captured by a camera in a physical environment, or a synthetically generated image of a virtual environment, among other such options. In this example, there can be one or more light sources that illuminate objects in the scene. These may include at least one primary light source, such as the sun for an outdoor daylight scene, and one or more secondary sources, as may correspond to less intense light sources such as streetlights, neon signs, and the like. There may also be other types of indirect light sources, as may relate to reflections from various objects in the scene. In the input scene image 100 of FIG. 1A, the sun is likely a primary light source, but the sun is not represented (e.g., visible) in the image. The location and brightness of the light from the sun, which can be impacted by factors such as weather and season, must therefore be estimated in many instances based only on what is visible in the scene. This can include, for example, identifying objects 102(a)-(c) represented in the scene, and inferring a general shape of the objects. The lighting effects associated with those objects can then be analyzed, such as to attempt to identify shadows 104(a)-(c) that are represented in the image 100 and associated with those objects. Other effects can be analyzed as well, as may relate to reflections, refractions, diffractions, and the like. The determined lighting effects can be used to attempt to infer aspects of an environmental lighting map for the scene, such as to work backwards from the locations and shapes of various shadows to the objects associated with those shadows, then extrapolating those rays or directions until they converge on one or more light sources. Other lighting representations can be used as well as discussed elsewhere herein, such as a spherical Gaussian or neural lighting model (e.g., an MLP or a latent representation of a pre-trained diffusion model) trained to learning lighting for a specific scene, or set of scenes. For the image of FIG. 1A, where the sun is likely the strongest and only primary light source, the shadows for objects in the scene can be used to estimate the location of the sun with respect to the scene, which can then be used to illuminate virtual objects to be placed in the scene.

FIG. 1B illustrates an image 120 of an example virtual object 122 to be effectively placed into the image of FIG. 1A so that the resulting image appears as if the virtual object, in this instance a vehicle, were originally included in the scene, such as where the vehicle is realistically represented to be driving on a road in the environment. In at least one embodiment, this virtual object can correspond to a 3D virtual asset, as may consist of a 3D mesh and a texture with material properties, and a view of the virtual object 122 can be generated that is appropriate for insertion into the scene. In this example, an object mask 140 can be generated for a representation 142 of the virtual object that is to be inserted into the image of FIG. 1C. The object mask in this example can indicate which pixels of the composite image should correspond to image data for the virtual object to be inserted, and which pixels of the image should correspond to the scene background as illustrated in FIG. 1A. Anti-aliasing and other such processing can be used to improve the perceived appearance of the insertion, such that the virtual object when inserted into the scene image appears to blend seamlessly into the image.

In order to provide perceived realism of insertion, however, the composite image should also include lighting effects with respect to the inserted object that appear to be consistent with the lighting effects of other objects in the scene. One approach to generating these lighting effects is to use the inferred environmental light map, generated using the shadows 104(a)-(c) and other lighting effects for objects 102(a)-(c) in the input scene image 100, and use the light map to generate lighting effects for the virtual object 122 to be inserted. In this example, this can result in at least a lighting effect 162 as illustrated in the view image 160 (or scene shadow map) of FIG. 1D. This mask may not be a true mask that is used to select pixels from one image or another, but may instead identify a region of the input scene image 100 to which lighting effects 162 are to be applied that are associated with the virtual object 122 to be inserted in a composite image to be generated. A compositing or synthesis process can then take the input scene image 100, the view of the virtual object 122, and the lighting effects, along with the relevant masks, and generate a composite image 180 as illustrated in FIG. 1E that illustrated the inserted object 122 with consistent lighting effects 162 based on the determined light map. In at least some embodiments, masks are not used or needed, such as where a generative model is trained to accept the input scene image 100 and some representation of the virtual object 120 and generate a composite image 180 with lighting effects without the need to explicitly generate masks for the object and/or lighting effects. Masks as illustrated, however, help to highlight portions of a composed image that are to be determined or considered when generating a composite image.

As mentioned, in order to faithfully perform virtual object insertion with cast shadows and lightning effects that appear realistic, or are at least consistent with those for other objects in a scene, it can be important in at least one embodiment to accurately estimate the environmental lighting conditions of the scene for which image data is to be rendered. Approaches in accordance with various embodiments can perform insertion of virtual objects or assets into an image of a scene or environment, for example, using a generative approach such as differential rendering. In at least one embodiment, such a process can provide improved performance relative to prior insertion approaches by, for example, using a machine learning model as a guide. One example approach can use expressive priors learned by one or more machine learning models, such as discriminators or two-dimensional (2D) diffusion models, to guide the estimation of an environmental map, as well as material properties of the object that is to be inserted and relevant camera parameters (such as ISP parameters), among other such options. One or more objects can be inserted at various locations in the scene over one or more iterations, and then synthetic composite images rendered with the inserted object(s) appearing to be located within the scene. These synthetic images can be propagated through a machine learning model, such as a diffusion model, that can provide a measure or determination of perceived realism. If there are portions of an image that do not sufficiently align with the priors learned by the diffusion model, or are otherwise out of a learned distribution of appearance aspects that were observed to occur in real world data, the corresponding gradients can be propagated back to the lighting representation through a differentiable rendering formulation, and can be used to help guide the optimization process. Expressive priors can be used that were learned by one or more 2D diffusion models on large scale data, providing advantages over previous solutions that used handcrafted (heuristic) priors or discriminator networks (e.g., generative adversarial networks (GANs)) to guide the intrinsic decomposition, or otherwise estimate the materials and lighting for a scene.

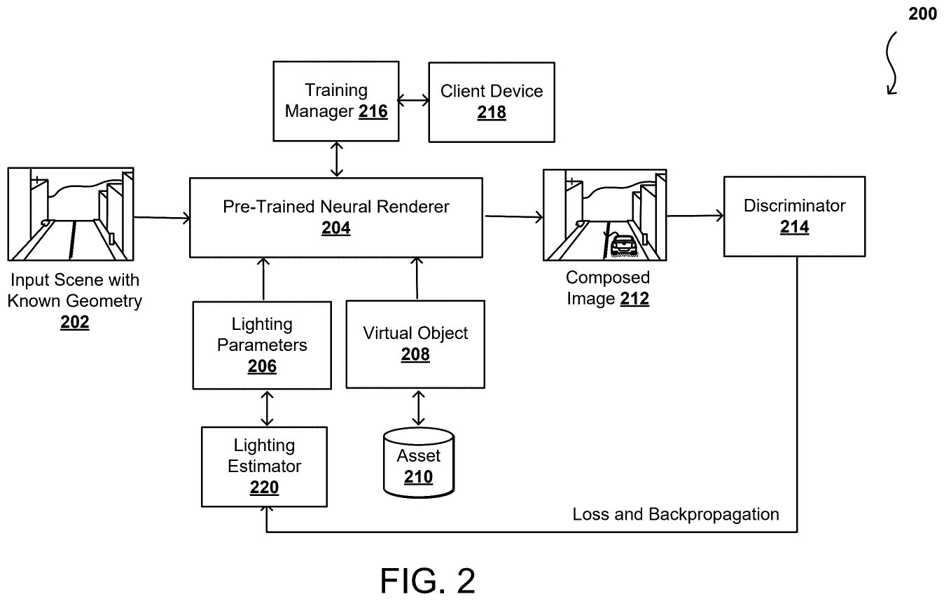

In at least one embodiment, one or more generative networks can be trained or updated (or pre-trained models obtained) to generate composite images with realistic lighting, among other such aspects. FIG. 2 illustrates an example system 200 that is able to use a discriminator as a guide to optimize lighting parameters, or to fine-tune a model to generate accurate lighting parameters for a scene, which can be input to a generative model (or learned by the model in some embodiments). Such optimized lighting parameters can allow rendering of composite images with consistent and/or realistic lighting effects for a specific scene, in at least one embodiment. In this example, one or more virtual objects 208 can be used during training to optimize a lighting map, or set of lighting parameters 206, for a specific scene, such as an input scene with known (or otherwise determined or inferred) geometry as represented in at least one input scene 202. A virtual object in at least one embodiment can correspond to a virtual asset, as may include a mesh and texture or other such components as discussed in more detail elsewhere herein. In many instances, the geometry and at least some material properties of the virtual asset will be known or otherwise determinable. For each training pass, at least one virtual object 208 can be inserted into a composed image 212 generated by a neural renderer 204, or other such image generator. In this example the renderer is a pre-trained neural renderer, but various other types of renderers or content generators can be used as well within the scope of the various embodiments. The virtual object 208 can be any appropriate type of object as discussed elsewhere herein, as may correspond to a virtual asset in an asset repository 210.

Tasks such as reconstruction and intrinsic decomposition of scenes from captured imagery can allow for a variety of operations, such as relighting and virtual object insertion. A neural renderer 204 as presented herein can use an inverse rendering framework that can perform joint reconstruction of scene geometry, spatially-varying materials, and precise lighting from one or more posed images with optional depth information. In one embodiment, a neural field can be used to account for primary rays, and an explicit mesh (reconstructed from an underlying neural field) used for modeling secondary rays that produce higher-order lighting effects such as cast shadows. By disentangling complex geometry and materials from lighting effects, such an approach allows for photorealistic relighting with specular and shadow effects on several outdoor datasets. Moreover, such an approach can support physics-based scene manipulations such as virtual object insertion with ray-traced shadow casting.

A user in this example can use a client device 218 to initiate training and/or provide information indicating how the training is to be performed. A training manager 216 can manage the training process, such as to indicate the number of iterations to be performed, and aspects of the image generation to be performed for each iteration. Training (including updating and/or fine-tuning a previously trained model) may occur until an end criterion is satisfied, such as when a network converges, a maximum number of iterations has been performed, a threshold or criterion (e.g., a perceived realism criterion) is satisfied, or all training data has been used for training, among other such options. For a given iteration, the training manager 216 can determine which virtual object(s) 208 to pull from an asset repository 210 or other such source, and can determine information such as the placement of the object in the scene and/or view of the scene to be generated (if not constrained by a single input image). The training manager can also be responsible for working with a lighting estimator 220 to obtain and/or optimize lighting parameters 206 to be used in rendering the composed image 212. Any of a number of different lighting parameters can be used or determined as may vary for different implementations or embodiments, including parameters such as intensity, color, location, orientation, direction, source type, light category, irradiance budget, irradiance quality, lighting mode, baked occlusion, lighting mode, decay, distance, strength, and/or contribution, among many other possibilities Such lighting parameters can be applied to the virtual object in order to generate a realistic composed image 212 where the lighting effects applied to the virtual object are to appear realistic and consistent with lighting effects for other objects represented in the composed image. Referring back to FIG. 1E, the lighting effects when applied to the inserted vehicle can help to determine aspects such as the size, shape, location, and density of the shadow created by the vehicle with respect to a specific light source, the brightness of the vehicle, the locations of reflections from the surface of the vehicle, and so on.

In this example, the quality of the composed images 212 generated by the neural renderer 204 over various training iterations can be determined using a machine learning model, such as a discriminator 214. A discriminator 214 in this example can be a type of neural classifier that can analyze an input image—such as a composed image generated by the neural renderer 204 during a training iteration—and can infer whether the image has a higher probability of being a real image, captured using a camera or other such physical capture device, or a synthesized/modified image that is inferred to have low probability of corresponding to a real, unedited, captured image. The discriminator can also output a measure of probability, confidence, or other such metric with respect to the real/synthesized (or other such) classification. An inferred classification along with a measure of probability, for example, can be considered a measure of perceptual realism, as it provides an inference as to how likely a human viewing a displayed composite image will perceive the image to be a real, captured image or a synthetic or composed image. In many instances, a human assessing an image to be synthetic or composed may consider factors such as inconsistent or unrealistic lighting effects applied to different objects, or an unnatural appearance of an object due in part to improper lighting effects applied to the surface of the object, etc. In at least one embodiment, a loss function can be used for the training that includes a loss term for the discriminator determination (or other measure of perceptual realism), with images that the discriminator 214 determines as being real with a very high confidence resulting in a lower loss value than images that the discriminator 214 determines to be synthetic with a very high confidence value. As long as the neural renderer 204 does not attempt to modify portions of the input scene image that are not associated with an inserted virtual object or a corresponding lighting effect, the portions of the composed image that will impact the outcome of the discriminator 214 should correspond primarily to the portions or regions of the image corresponding to the inserted virtual object(s) and associated lighting effects, such as shadows or reflections. This can include, for example, aspects such as the size, shape, and placement of shadows with respect to an inserted object, as well as the appearance of the virtual object itself as may be based in part on the reflection of light from the surface of the object—as may be determined using material properties of the virtual object, for example and without limitation. If the discriminator indicates with high confidence that a composed image 212 for an iteration is a real image, then the appearance of the inserted virtual object and corresponding lighting effects should be very similar to what the discriminator has been trained to expect for real images. If, on the other hand, the discriminator indicates with high confidence that the image is synthetic, then the composed image differs significantly from what the discriminator expects, which in this example has a high probability of being impacted by incorrect or suboptimal lighting parameters. For determinations in between, the extent of the unexpected differences can be used to adjust the parameters of one or more models being trained in order to attempt to improve the quality, or reduce the loss, observed for future training iterations.

In at least one embodiment, the model being trained can include a lighting estimator 220. The lighting estimator 220 in at least one embodiment can be a machine learning model such as a multilayer perceptron (MLP) or other feedforward artificial neural network that can provide an implicit representation of the lighting for a specific scene once trained or fine-tuned for a particular scene. The lighting estimator 220 might start with a default set of lighting parameters, as may be learned or selected for a specific type of scene or may be set at random, etc., and can attempt to optimize or improve on the lighting parameters that are appropriate for a specific scene. While the estimator can start from random lighting parameters, the amount of training time and resources may be reduced by starting with a default set of parameters for a particular type of scene, such as a default parameter set including lighting parameters for the sun being directly overhead on a sunny day for an outdoor, daytime scene. In some embodiments other types of input can be provided, such as example images of the scene or user input with respect to the scene, but such additional input is not required in all embodiments, as a lighting estimator can start from, and then refine, a default set of lighting parameters for a particular scene. In this example, after a training iteration the loss value can be provided and used during a backpropagation step to adjust the parameters of the neural estimator. For embodiments that use another type of lighting optimizer, a different type of value may be returned that can help to modify the lighting parameters to attempt to improve the results as determined by the discriminator. In such embodiments, the process may be implemented as an optimization process for a set of lighting parameters for a specific scene.

The lighting parameters can be adjusted in this example such that the lighting estimator (or set of lighting parameters) can, after optimization or training, provide an accurate representation or digital twin of the lighting of the specific scene. This representation can then be used when inserting a virtual object into any image associated with the scene, in order to allow for an accurate match of the lighting of the virtual object to the lighting of other objects in the scene, which can help to provide for a high level of perceived realism of the insertion. In one embodiment, a lighting estimator 220 can attempt to adjust the lighting parameters to change aspects such as the location, color, and brightness or intensity of one or more light sources with respect to the scene. The reconstructed lighting information can then be used to light or shade any virtual object to be digitally inserted into an image of the scene. The optimization process will not be straightforward in many instances, as the realism can be impacted by factors such as the presence of random textures, multiple light sources, or other variations that can lead to incorrect inferences of scene lighting.

In one example, an input scene 202 may include, or be associated with, various known geometry. This geometry may relate to various objects in, or features of, the scene, as may relate to the ground position, object shapes, and features of the surroundings that can be reconstructed from LiDAR or other such data that may have been captured in a physical environment corresponding to the scene. An instruction or request can be received to insert a virtual object into this image. As discussed, the virtual object could be any appropriate object, as may have been created by an artist or generative model, or may have been represented in captured image data, among other such options. In some instances, a virtual asset may be comprised of a geometric mesh and a texture, with material properties, for which a view can be rendered to be inserted into the input scene image. In this example, the actual lighting parameters for the scene are unknown, such as may correspond to an image of an actual environment that was obtained without any other information about the lighting, objects, materials, or environment associated with the image. In this example, a differentiable object insertion process can be used by a neural renderer 204 to generate a composed version of the input scene 202 that includes a view of the virtual object 208 with lighting or shading applied based in part upon the provided lighting parameters 206. Use of a differentiable process enables the lighting parameters to be differentiably propagated in order to optimize the lighting information that is to be used to generate a composed image 212. In the example of FIG. 2, the results from the discriminator 214 for individual composed images can be used to guide the reconstruction performed by the neural renderer 204.

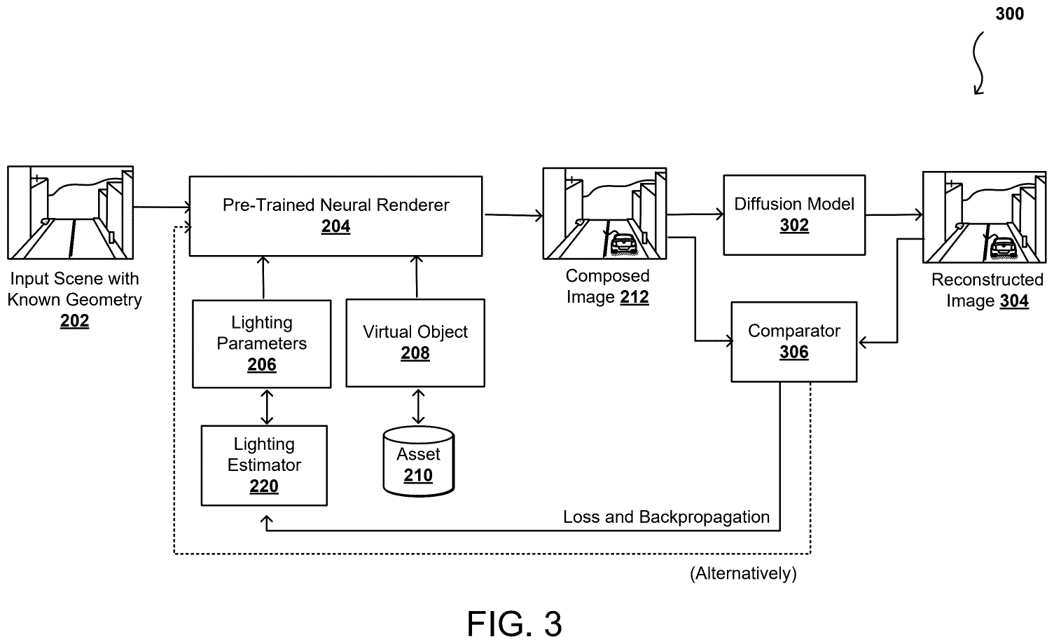

FIG. 3 illustrates components of another example system 300 that can be used to provide for realistic insertion of virtual objects into an input scene image, in accordance with at least one embodiment. It should be understood that reference numbers may be carried over between figures for similar elements for simplicity of explanation and understanding, but such usage should not be interpreted as a limitation on the scope of the various embodiments unless otherwise specifically stated. In this example, neural renderer 204 is again used to insert a virtual object 208 into an input scene 202 using a set of lighting parameters, which the system attempts to optimize for the specific scene, either directly or by fine-tuning a lighting estimation model, among other such options. In this example, however, a diffusion model 302 is used to determine the appropriate loss value(s) to use during training. As with the system described with respect to FIG. 2, this example system 300 can generate a composed image with an inserted virtual object 208 with lighting effects applied according to a set of lighting parameters for each training iteration, then can use a determined loss value (or other such metric) to modify the lighting parameters, or the weights of a neural estimator inferring the lighting parameters, for subsequent training iterations. A diffusion model-based approach can be more discrete than a discriminator-based approach, as the loss can be applied between a denoised (or reconstructed) image and an original composed image.

In this example, a composed image 212 generated by a pre-trained neural renderer 204 can be passed to a diffusion model 302. A diffusion model can function as a substitute for the human eye, as it can determine whether an image appears realistic or not and can provide an indication of the inferred realism, which can then be used to adjust the lighting parameters until consistently realistic-appearing images are produced using those parameters. This diffusion model 302 can generally be any appropriate diffusion model—such as a diffusion probabilistic model, noise-conditioned score network, or denoising diffusion probabilistic model—as may be able to be trained using large-scale data to be able to handle a wide variety of types of scenes for a wide variety of viewpoints. A diffusion model in at least one embodiment can define a Markov chain of diffusion steps to iteratively add random noise to input image data, then iteratively remove noise in a learned manner in order to generate an accurate (or at least realistic) reconstruction of the input image data. In this example, the diffusion model will take the input composed image 212 and add noise over a number of iterations, then will attempt to intelligently denoise the image over a number of iterations to attempt to reconstruct the input composed image using the learnings of the diffusion model, generating an output reconstructed image 304. A diffusion model used for such purposes can be a generative three-dimensional (3D), wherein random (or semi-random) noise can be provided as input and the model can output high fidelity 3D image content through an iterative denoising process. Such a diffusion model can be very accurate with respect to lighting conditions, such that any inserted objects can be well blended into the scene.

A reconstructed image 304 output by the trained diffusion model 302 can be compared against the composed image 212 that was input to the diffusion model 302, such as by using a comparator 306. The comparator can take various forms, such as a module that is able to calculate a contrastive loss (or other measure of perceptual realism) between a sample generated by the diffusion model and an original image, which in some embodiments can include comparing embeddings (e.g., latent embeddings) for the respective instances of image data. The determined loss value, which may be combined with loss values for other loss terms of a loss function in some embodiments, can be returned to a lighting estimator 220, which might be a machine learning model with parameters or weights that can be updated based on the loss values to improve performance with respect to generating lighting parameters or other information for a specific scene. In at least one embodiment, the loss function can include a term for a score distillation sampling (SDS) loss frequently used with diffusion models to optimize a determined loss. The use of a loss such as an SDS loss allows for optimizing samples in an arbitrary parameter space, such as a 3D space, where the process allows for mapping back to images in a differentiable way. In at least one embodiment a 3D scene parameterization can be used to define this differentiable mapping. Backpropagation can involve first finding a gradient for the composed image, and an SDS loss is one way to compute such a gradient. The image can be locally perturbed by a relatively small amount, such as by adding one step (or multiple steps) of noise and passing the image into the diffusion model. The loss, similar to an L1 loss, can then be applied to the diffused image and the composite image and used to adjust the light parameters based at least in part on the result.

While optimizing the SDS loss alone can result in reasonable scene appearance, additional regularizers and optimization strategies can be used in at least some embodiments to improve geometry where neural renderers, such as NeRFs, are used. An object to be inserted in at least one embodiment can be an explicit digital asset that can include a three-dimensional geometric mesh and a texture that can be projected onto the mesh. There may be other types of objects to be inserted into an image of a scene as well. This may include, for example, views of one or more objects, volumetric data representations, or other implicit representations. These implicit representations can be generated by a neural network, for example, such as a fully-connected neural radiance field (NeRF) network. A trained NeRF can be used to generate representations of objects from any appropriate point of view. NeRF inference in general relates to the computation of the radiance and density at given 3D positions a scene, as may include the integration over ray segments and outputting of different extended data, such as surface normal, segmentation identifiers, material parameters, or 3D motion data. There are various other ways to generate, provide, or render digital objects (or views of those objects) that can be used as well within the scope of various embodiments. As mentioned, however, it can be difficult to combine or composite these into a single image (or video frame or view of a virtual environment, etc.) in such a way as to provide for consistent lighting, particularly for secondary lighting effects such as shadows, reflections, or other such indirect and/or diffuse lighting effects. Trained neural renderers as used herein can be coherent, with high-quality normals, surface geometry and depth, and can be relightable using, for example, a Lambertian shading model. Once trained and fine-tuned or optimized, a lighting estimator model can function as a digital lighting map for the specific scene for which it was trained, and can provide lighting parameters or other information to the neural renderer for use in applying consistent lighting effects to virtual objects added into a scene image.

As mentioned, however, the lighting parameters 206 in other embodiments or examples need not be generated or inferred using a neural (or other) lighting estimator, but may instead correspond to a set of parameters that can be optimized using such a process. The parameters can be encoded or represented in any appropriate form, such as points in a multi-dimensional space or pixel values in an image, among other such options. A lighting estimator may then correspond to an optimizer that can update the values of these parameters based on information from the discriminator, diffusion model, or other such evaluation tool as discussed and suggested herein. As mentioned, the lighting parameters can start with a set of default values that may or may not be determined using information for the specific scene, although the ability to select default values that may be at least somewhat appropriate for a given scene, or type of scene, may help to reduce the time, effort, and/or resources needed to determine appropriate, if not optimal or otherwise tuned, lighting parameters. In at least one embodiment, lighting parameters for such a scene can be freely optimizable parameters, such as may be encoded in a neural network or stored to an appropriate image or other representation. In one example, the parameters can be encoded to a spherical Gaussian or NeRF model. In such an example, a neural renderer might request lighting information or parameters for a particular direction, and the model might provide intensity, color, or other information that can be used by the renderer in lighting the scene. In one example, the lighting parameters for a scene once determined can be encoded to an environmental map or other such multi-dimensional representation.

Using such an approach, there might be one lighting model optimized or fine-tuned for each respective scene. In some embodiments, the models may be considered together to provide lighting information for a collection of scenes in a single environment. In some instances where scenes in an environment may be similar, the model for a given scene may be applied to other scenes, such as scenes in a similar environment or of a similar type. For example, if a model is fine-tuned to represent lighting for a city block in a particular city during daylight hours, where the lighting is primarily due to a current location of the sun or other primary light source, then that model might be reused for similar blocks under similar conditions, although such a model would not capture smaller differences as may be due to reflections from specific objects located in a particular scene.

In at least one embodiment, a machine learning model such as a NeRF—which can be trained to effectively provide a digital twin of a particular scene—can generate images of the scene in which an object is to be inserted. The NeRF can know and provide the geometry information for the scene. In such an embodiment, the NeRF can also learn lighting information for the scene if not already determined. In this way, the optimizing of the lighting parameters can be performed with respect to the NeRF, instead of using a separate model, which can then determine the relevant lighting parameters for any virtual object to be inserted into the scene. The NeRF can be used to generate novel views of a scene in some embodiments, and the neural renderer 204 can be used to insert a virtual object 208 with a perspective that is appropriate for the novel view, with realistic lighting determined according to the provided lighting parameters.

Although the example systems of FIGS. 2 and 3 discuss the use of a neural renderer 204, a differential renderer can be a rendering module that does not include of involve a neural network. In at least one embodiment, a single neural network can be used to analyze a composed image 212, where that network can take the form of a diffusion model or discriminator, among other such options. Neural networks may be used for other purposes as discussed, such as for use in generating an input scene image, representing the lighting information, or performing differentiable rendering, etc. As mentioned, if a network such as a NeRF is used for the differential rendering, there may not need to be a separate network or model to represent the lighting parameters as those parameters can be represented within the NeRF itself.

In some embodiments, an optimization process might start with significant or primary light sources, then optimize for less impactful light sources. For example, the process might attempt to optimize for the location and intensity of the sun and/or moon for outdoor scenes, until such point as the optimization process reaches a relatively consistent state, then may attempt to optimize for smaller light sources, such as reflections or less intense light sources, such as reading lights visible through a window or headlights on a vehicle, etc. As mentioned, the realism of lighting effects it not limited to shadows or other such effects, but also aspects such as the appearance of specific objects in the scene, such as where matte objects should appear different than objects with reflective or glossy surfaces, etc.

When using a diffusion model, it is possible in some instances that the diffusion model may get “stuck” in a local minimum. In order to attempt to avoid such issues, approaches presented herein can use physics-based rendering so that the diffusion model has a sense of lighting rather than only considering the data as pixel data. This may include using ray tracing as part of the image rendering or formation process, where the ray tracing is physics-constrained. Additional considerations may include, for example, the material properties of a virtual object to be inserted into a scene, as well as a response curve for a virtual camera, among other such options. In some embodiments the object does not have to be a virtual asset, but may instead be generated by a generative model such that the material properties are on the object. A function such as a bidirectional reflectance distribution function (BRDF) can then be used as part of the optimization process. In at least one embodiment, a 3D model can be used that can perform path tracing for multiple views of a scene, such that multiple objects can be inserted into a scene at various locations then viewed from multiple different angles, including potentially novel views.

In at least one embodiment, the neural renderer may be a NeRF or similar renderer that can be trained to learn the specific lighting for a given scene. In such an example, the loss values from a discriminator, diffusion model, or other such source can be used to further train or fine-tune the NeRF such that the NeRF itself can apply optimized lighting parameters or effects for a scene without having to have another source provide optimized or tuned lighting parameters for a given scene. In an example such as that illustrated in FIG. 3, the loss values from the comparator 306 would not then be provided to a lighting estimator 220 but can be used to adjust parameters or weights of the neural renderer 204 (e.g., the NeRF) so the NeRF is fine-tuned for that specific scene, and can apply the appropriate lighting effects to any object to be inserted into that scene (given appropriate data for the object as discussed and suggested herein). The NeRF can perform physics-based rendering, such as discussed with respect to the neural renderer.

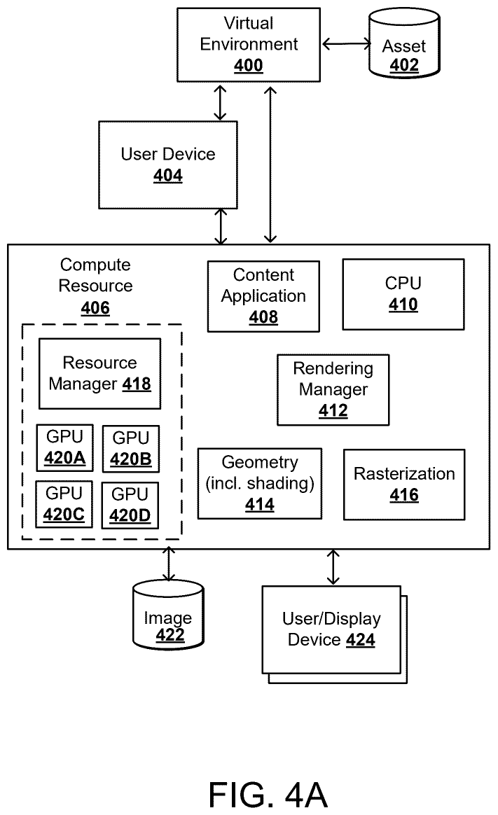

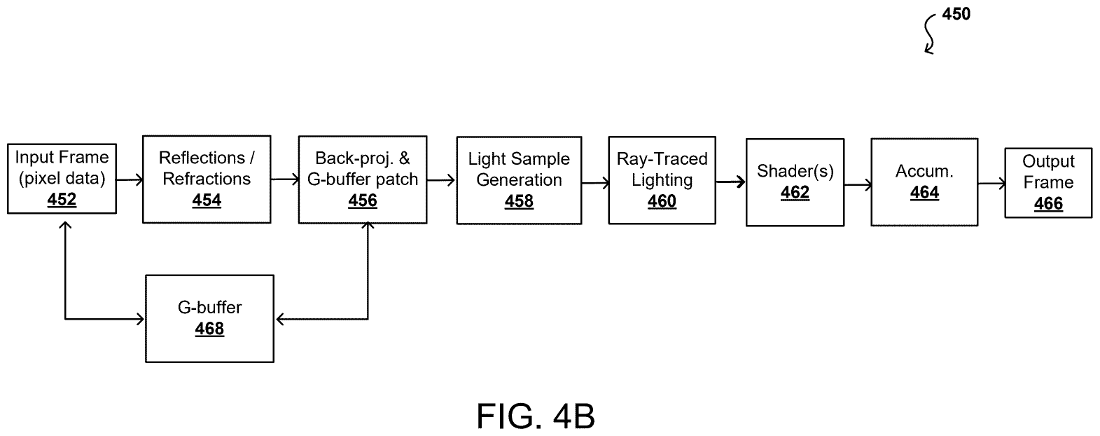

FIG. 4A illustrates an example virtual environment 400 for rendering an image, video frame, or other instance of image-related content in accordance with at least one embodiment. Such a system can include or incorporate functionality as presented herein to allow for compositing of content from various sources, such as captured or pre-rendered images, NeRF objects, and/or traditionally rendered objects or assets, among other such options. In this example, a composite image is to be rendered for a scene (or other view, portion, or region) in a virtual environment 400, although images can be rendered for semi-virtual or real environments as well using such a system. The virtual environment 400 may include geometry and other data representative of shapes or objects in the environment, such as three-dimensional (3D) objects that are representative, or are to be included in, a scene that occurs within the environment, as may include foreground objects such as people or vehicles, or background objects such as roads and buildings, among other such options. In at least some embodiments, at least some of the content to be inserted may be obtained from a source such as an asset repository 402, or other such location, which can contain content—such as geometry, textures, and density data—that can be used to render one or more objects placed into a view of the scene. In at least some embodiments or instances, there can be a user device 404 running a content generation or management application that can allow a user to select assets 402 and at least a relevant portion of the virtual environment 400 to use in rendering a composite image for the scene. The user device 404 can also allow a user to control aspects of the image to be rendered, such as the location or pose of an object in the scene, as well as a viewpoint and other parameters of a virtual camera to be used to render an image of the virtual environment 400. A generated image can be stored to an image repository 422 or provided for display on one or more devices 424, among other such options.

In this example, at least one compute resource 406 is used to perform the rendering. This resource may correspond to one or more servers, for example, that may be located locally or across at least one network, among other such options. In some embodiments, the rendering may instead be at least partially performed on the user device 404. The compute resource 406 may obtain or receive data to be used for the rendering, as may include geometry, texture, and density data for the virtual environment or assets, as well as information about the locations and poses of those objects in the scene and parameters of a virtual camera to be used to determine the view of the scene to be rendered. This information may be received to a content application 408, for example, that may be executing on a central processing unit (CPU) 410 of the compute resource that is responsible for tasks such as collecting data, causing an image to be rendered, and performing any formatting or encoding of a produced image, among other such operations. The content application can work with a rendering manager 412, for example, which can be responsible for coordinating operations of a rendering pipeline executing on the compute resource 406, as may include modules 414, 416 or processes responsible for tasks such as geometry related tasks (including lighting and shading tasks) and rasterization, among other such tasks. In at least some embodiments, at least some of these rendering tasks may be performed using one or more GPUs 420A-D of the compute resource, as well as potentially one or more processors or compute instances (physical or virtual) of one or more other compute resources.

A task such as light transport simulation (e.g., ray tracing, path tracing, ray marching, etc.) or volumetric sampling can be performed using a single processor, such as a single GPU, or can have operations distributed across multiple GPUs 420A-D). In this example, there can be a pool or set of GPUs 420A-D, and a resource manager 418 can be at least partially responsible for allocating a GPU to perform the processing for an operation. If it is desired or beneficial to use more than one GPU then the resource manager 418 can allocate one or more GPUs having the appropriate capacity or capabilities. This can include allocating a number of GPUs indicated in a request, or determining a number of GPUs to allocate based in part on the request. In some embodiments, the resource manager may also be able to monitor an available bandwidth or memory in order to determine which and how many GPUs to allocate, such as where having high bandwidth capacity can allow operations to be spread across a greater number of GPUs, where bandwidth impact due to forwarding ray information will not be as critical, while having a bandwidth constrained system may cause the resource manager to attempt to allocate as few GPUs as possible in order to attempt to reduce the number of forwarding messages required.

In at least one embodiment, a partitioning of data can be performed by a rendering manager 412, for example, and the assigning of data to different processors can be performed by a resource manager 418 of the system. The resource manager can receive information from the rendering component, and can select appropriate processors from a pool of available processors 420 or processor capacity. In some embodiments, the rendering application can choose the partitioning, while in other embodiments the renderer may have no control over the data partitioning, which may be done by a separate management component (not illustrated in FIG. 4A).

FIG. 4B illustrates an example image generation pipeline 450 that can be used in a virtual environment 400—such as that illustrated in FIG. 4A—to render one or more images, such as video frames in a sequence. In this example, pixel data 452 for a current frame to be rendered (as may include G-buffer data for primary surfaces) can be received as input to a reflections and refractions component 454 of a rendering system. Reflections and refractions component 454 can use this data to attempt to determine data for any determined reflections and/or refractions in the pixel data, and can provide this data to a back-projection and G-buffer patching component 456, which can perform back-propagation as discussed herein to locate corresponding points for those reflections and refractions, and use this data to patch the G-buffer 468, which can provide updated input for a subsequent frame to be rendered. The data can then be provided to a light sample generation component 458 to perform light sampling, a ray-traced lighting component 460 to perform ray-traced lighting, and one or more shaders 462, which can set the pixel colors for the various pixels of the frame based at least in part upon the determined lighting information (along with other information such as color, texture, and so on). The results can be accumulated by an accumulation module 464 or component for generating an output frame 466 of a desired size, resolution, or format.

In at least one embodiment, a shader 458 can perform the backward projection step. Once a backward projection pass has finished, and gradient surface parameters have been patched into the current G-buffer, a renderer can execute the lighting passes. Using information from the lighting passes and the lighting results from the previous frame, gradients can be computed then filtered and used for history rejection. Such an approach can be used to compute robust temporal gradients between current and previous frames in a temporal denoiser for ray traced renderers. Such a backward projection-based approach can also work through reflections and refractions, and can work with rasterized G-buffers. Previous approaches for backward projection omitted any G-buffer patching and relied on the raw current G-buffer samples instead, which also results in false positive gradients. Patching the surface parameters can eliminate false positives in the vast majority of cases, making the denoised image very stable yet still quickly reacting to lighting changes. Once the backward projection pass is finished, and gradient surface parameters have been patched into the current G-buffer, a renderer can execute the lighting passes. Using the information from the lighting passes and the lighting results from the previous frame, the gradients are computed then filtered and used for history rejection. As discussed with respect to FIGS. 3A-3D, relighting and compositing of NeRF objects and non-NeRF objects can be placed at various location in such a pipeline, such as before or after ray-traced lighting 460 is performed, or as part of an accumulation process 464, among other such options discussed or suggested herein.

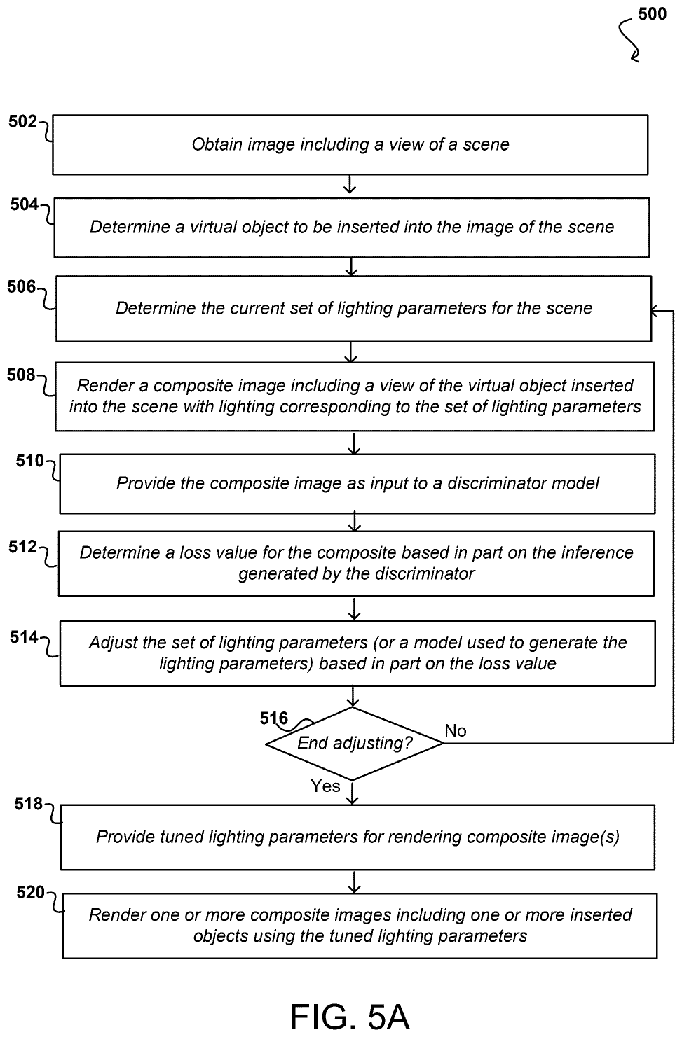

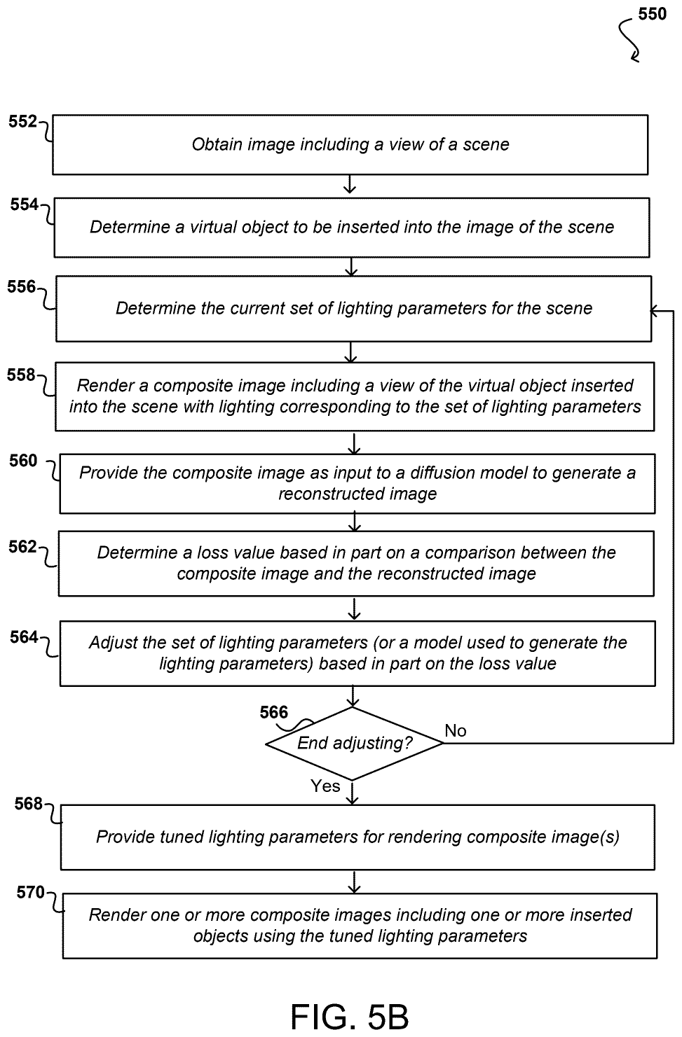

FIG. 5A illustrates an example process 500 to determine and optimize lighting parameters that can be used to render a composite image including at least one inserted object that can be performed in accordance with at least one embodiment. It should be understood that for this and other processes presented herein that there may be additional, fewer, or alternative steps performed or similar or alternative orders, or at least partially in parallel, within the scope of the various embodiments unless otherwise specifically stated. Further, although this example will be discussed with respect to virtual objects and existing scene images, there can be other types of data or content used to render a novel image, video frame, or other instance of digital content as well within the scope of various embodiments. In this example, an image is obtained 502 that includes a view of a scene. This may include a captured image of view of one or more objects in a physical environment, or a generated image of one or more objects in a simulated environment, among other such options. At least one virtual object, such as a virtual object or image-based representation of an object, can be determined 504 that is to be inserted into the image of the scene, or otherwise represented in a composite or synthetic image to be rendered, which includes a view of the virtual object in the scene represented in the obtained image. In at least one embodiment, the scale, orientation, placement, and/or other aspects of the object in the composite image should be at least reasonably consistent with the other objects or features of the scene.

In order to help ensure that the inserted object blends seamlessly with the other objects in the scene, an attempt can also be made to ensure that the lighting effects applied to the inserted object are consistent with those applied to other objects in the scene. This can include, for example, ensuring a brightness of illumination that is consistent with the other objects, as well as the generation of consistent shadowing and reflections, among other lighting and/or shading aspects. In at least one embodiment, for a first round of training or optimization, an initial set of lighting parameters can be determined 506 for the scene. This may include a random or default set of lighting parameters, such as may correspond to a single, point light source at a default distance directly “above” a center point of the image, for example. In this example, “above” may correspond to a point along a normal to a primary plane, axis, or surface of the image, such as ground or street level for a physical environment. In other embodiments, a set of lighting parameters may be selected that have been determined to be appropriate for scenes of a similar type, such as an outdoor scene during the day or an indoor scene at night. In other embodiments, an initial processing of the input image can be performed to select an initial set of lighting parameters, among other such options.

In this example, a composite image can be rendered 508, such as by performing differential rendering using a neural renderer. The composite image to be rendered can include a view of the virtual object inserted into the scene as represented in the obtained scene image, with lighting effects applied that correspond to the current set of lighting parameters for the scene. As mentioned, there may be more than one object inserted at more than one location during a training and/or optimization process, and different objects can be placed at different locations for different composite images generated in different iterations, in order to obtain a more accurate representation of lighting across the scene. For each composite image generated in this example, the composite image can be provided 510 as input to a discriminator model. The discriminator model can analyze the input composite image to attempt to determine whether the composite image is an actual image, such as one captured by a camera of objects in a physical environment, or a synthetic (or otherwise manipulated) image, such as one where content was added into an image or virtual assets were used to generate an image. The discriminator can also provide some measure of confidence or probability for this inference, or classification of the composite image. A loss value (or other measure of perceptual realism) can be determined 512 for a given composite image based in part on the inference generated by the discriminator. As mentioned, a classification such as “real” with high probability will result in little loss for a respective loss term, while a classification such as “synthetic” with high probability can result in a relatively high loss for a respective loss term. In at least one embodiment, an attempt can be made to adjust the lighting parameters so that the loss value for generated composite images is minimal (ideally zero in this example), regardless of the placement of a virtual object in the composite image. For a discriminator, this can involve adjusting lighting parameters until a realism threshold is at least met consistently, such as where the discriminator classifies composed images as real images with at least a minimum probability over at least a number of consecutive composed images. In this example, the set of lighting parameters can be adjusted 514 or otherwise optimized based at least in part upon the loss value(s), which may involve adjusting one or more weights or parameters of a model being trained to generate accurate lighting parameters for a scene. The adjusting can be performed using any appropriate training and/or optimization process, such as discussed or suggested in more detail elsewhere herein. In at least one embodiment, this process can continue until at least one end criterion is satisfied. This may include, for example, loss values that are consistently below a maximum loss threshold, convergence of an estimator network, a maximum number of training iterations or time, or another such criterion. If no such criterion is satisfied, such that it is determined 516 that the training and/or optimizing process should continue, then the process can continue for a subsequent composite image that is rendered using updated lighting parameters resulting from the previous iteration. If at least one such criterion is satisfied such that training and/or optimization should stop for a current scene, for example, then the tuned lighting parameters (or fine-tuned model for generating lighting parameters) for this scene can be provided 518 to render composite images of the scene with consistent lighting for inserted objects. One or more composite images can then be rendered 520 using the tuned lighting parameters to light and/or shade one or more virtual objects inserted into a scene.

FIG. 5B illustrates another example process 550 to determine and optimize lighting parameters that can be used to render a composite image including at least one inserted object that can be performed in accordance with at least one embodiment. In this process, however, composite images are analyzed using a diffusion model instead of a discriminator, although other types of models, networks, or approaches can be used as well within the scope of the various embodiments. In this example, an image is obtained 552 that includes a view of a scene as discussed with respect to FIG. 5A. At least one virtual object can be determined 554 that is to be inserted into the image of the scene, or otherwise represented in a composite or synthetic image to be rendered, which includes a view of the virtual object in the scene represented in the obtained image. In order to help ensure that the inserted object blends seamlessly with the other objects in the scene, an attempt can also be made to ensure that the lighting effects applied to the inserted object are consistent with those applied to other objects in the scene. As with the process of FIG. 5A, an initial set of lighting parameters can be determined 556 for the scene using one of a number of possible approaches. A composite image can be rendered 558 that can include a view of the virtual object inserted into the scene as represented in the obtained scene image, with lighting effects applied that correspond to the current set of lighting parameters for the scene.

Individual composite image generated in this example can be provided 560 as input to a diffusion model. As mentioned, a diffusion model can iteratively add random (or semi-random) noise to the composed image, then use its learnings to iteratively and intelligently remove the added noise to attempt to reconstruct the original composite image. The diffusion model can then output a reconstructed image after a sufficient amount of noise removal has been performed or another reconstruction criterion is satisfied. The reconstructed image can then be compared against the input composite image that was generated by the neural renderer. This comparison can be performed using any of a number of different types of comparators using any of a number of different metrics to generate a measure of similarity (or difference) between the original and reconstructed images. In this example, a loss value (or other measure of perceptual realism) can be determined 562 based in part on a comparison between the composite and reconstructed image, such as by using a loss function with at least a loss term corresponding to the comparison. In at least one embodiment, an attempt can be made to adjust at least a subset of the lighting parameters so that the loss value for generated composite images is minimal (ideally zero in this example) and relatively consistent, regardless of the placement of a virtual object in the composite image. This may include attempting to optimize the parameters until a measure of perceptual realism consistently satisfies a realism threshold, which for a diffusion model can involve the comparator determining a loss or measure of differences that is below a specific threshold value. In this example, the set of lighting parameters can be adjusted 564 or otherwise optimized based at least in part upon the loss value(s), which may involve adjusting one or more weights or parameters of a model being trained to generate accurate lighting parameters for a scene. In at least one embodiment, this process can continue until at least one end criterion is satisfied. If no such criterion is satisfied, such that it is determined 566 that the training and/or optimizing process should continue, then the process can continue for a subsequent composite image that is rendered using updated lighting parameters resulting from the previous iteration. If at least one such criterion is satisfied such that training and/or optimization should stop for a current scene, for example, then the tuned lighting parameters (or fine-tuned model for generating lighting parameters) for this scene can be provided 568 to render composite images of the scene with consistent lighting for inserted objects. One or more composite images can then be rendered 570 using the tuned lighting parameters to light and/or shade one or more virtual objects inserted into a scene.

Aspects of various approaches presented herein can be lightweight enough to execute in various locations, such as on a device such as a client device that include a personal computer or gaming console, in real time. Such processing can be performed on, or for, content that is generated on, or received by, that client device or received from an external source, such as streaming data or other content received over at least one network from a cloud server 620 or third party service 660, among other such options. In some instances, at least a portion of the processing, generation, compositing, and/or determination of this content may be performed by one of these other devices, systems, or entities, then provided to the client device (or another such recipient) for presentation or another such use.

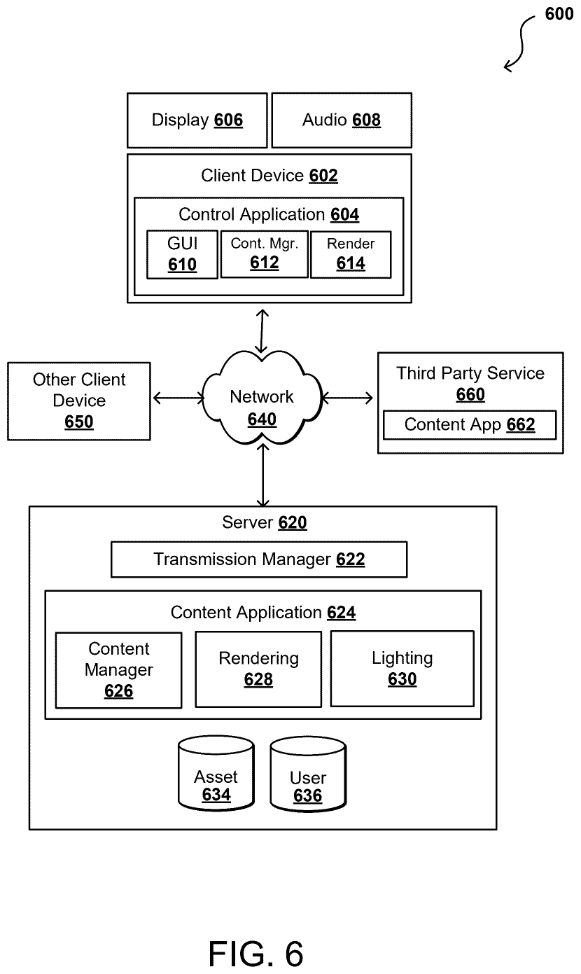

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., implicit and/or explicit object representations) from an asset repository 634 to be determined by a content manager 626. A content manager 626 may work with a rendering module 628 to generate or select objects, digital assets, or other such content to be placed in a scene or other virtual environment. Views of these objects can be rendered by the rendering module 628, such as by insertion into an input scene image, and provided for presentation via the client device 602. In at least one embodiment, this rendering module 628 can work with a lighting module 630 to provide optimized lighting parameters for a particular scene. This may involve optimizing lighting parameters for a particular scene, or training a neural network to provide accurate lighting parameters for a particular scene, among other such options. At least a portion of the rendered and/or composited (or otherwise generated or selected) content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and rendering module 614 for use in providing, synthesizing, rendering, compositing, modifying, or using content for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

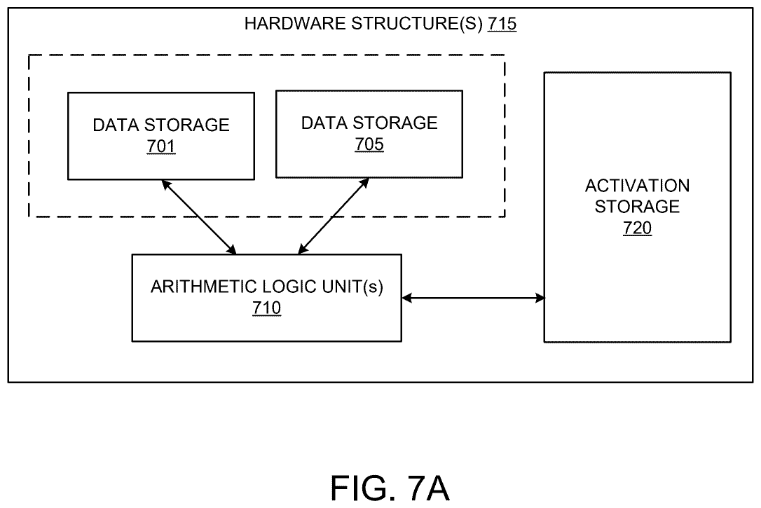

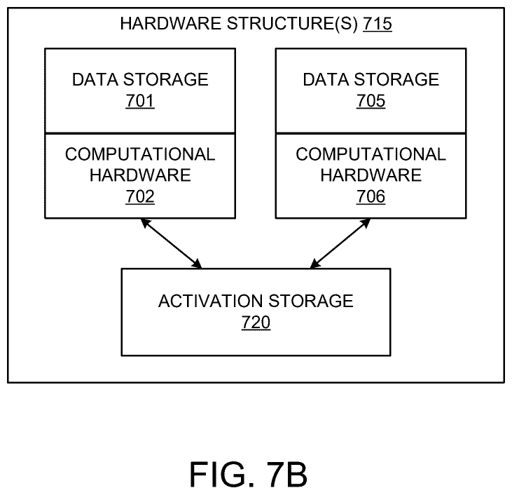

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

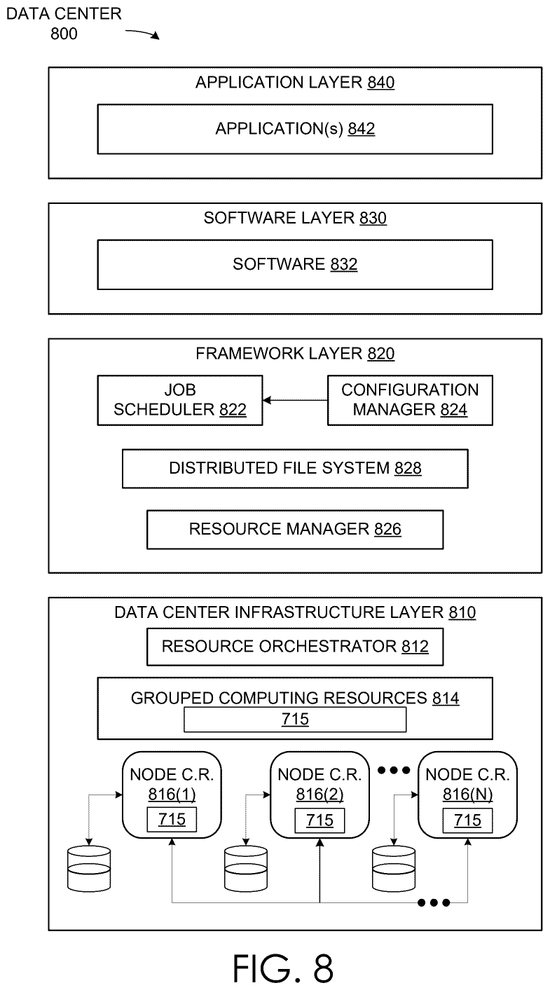

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to render objects of different types, determine consistent secondary lighting effects for those objects, then composite the objects using the secondary lighting effects to generate composite images.

### Computer Systems

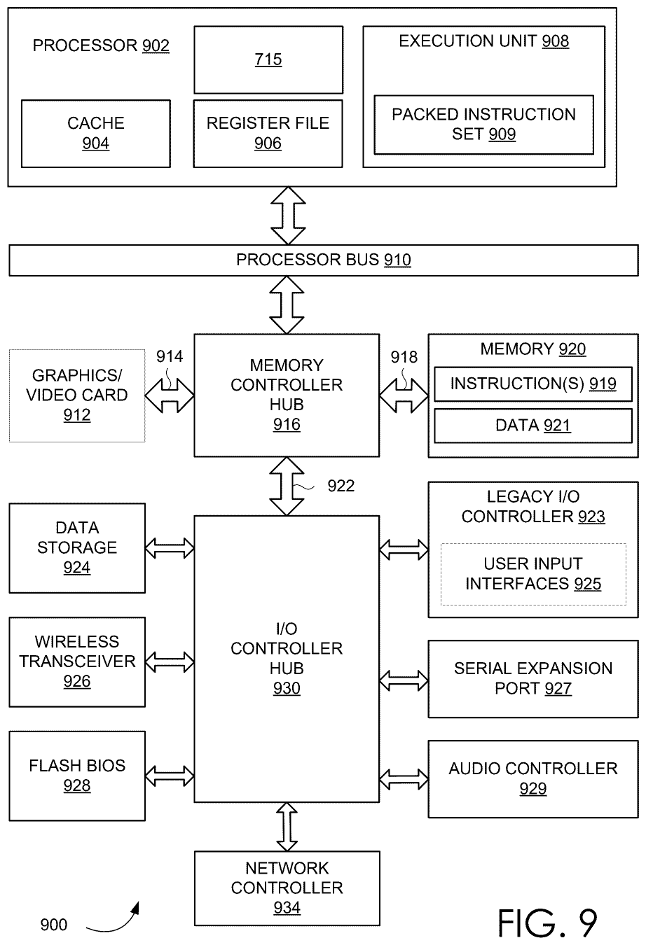

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to render objects of different types, determine consistent secondary lighting effects for those objects, then composite the objects using the secondary lighting effects to generate composite images.

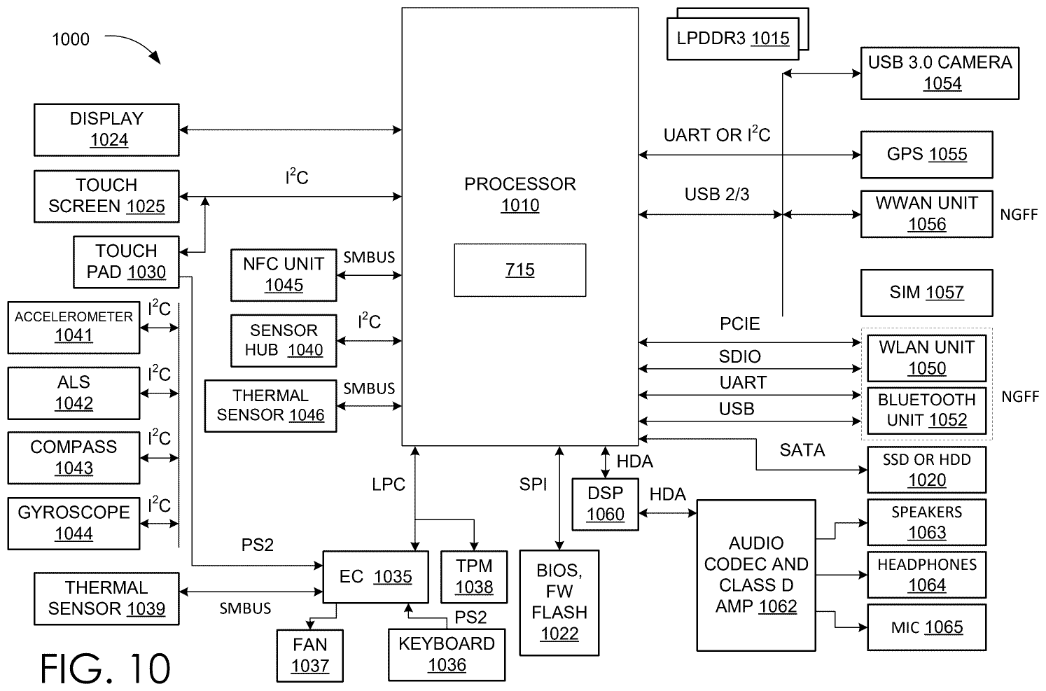

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, system 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to render objects of different types, determine consistent secondary lighting effects for those objects, then composite the objects using the secondary lighting effects to generate composite images.

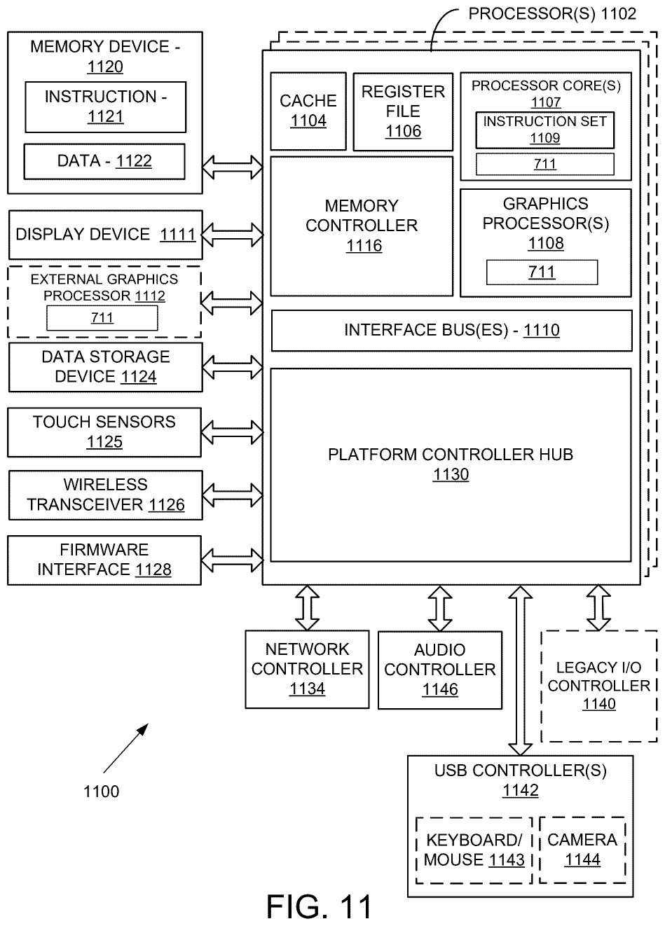

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to render objects of different types, determine consistent secondary lighting effects for those objects, then composite the objects using the secondary lighting effects to generate composite images.

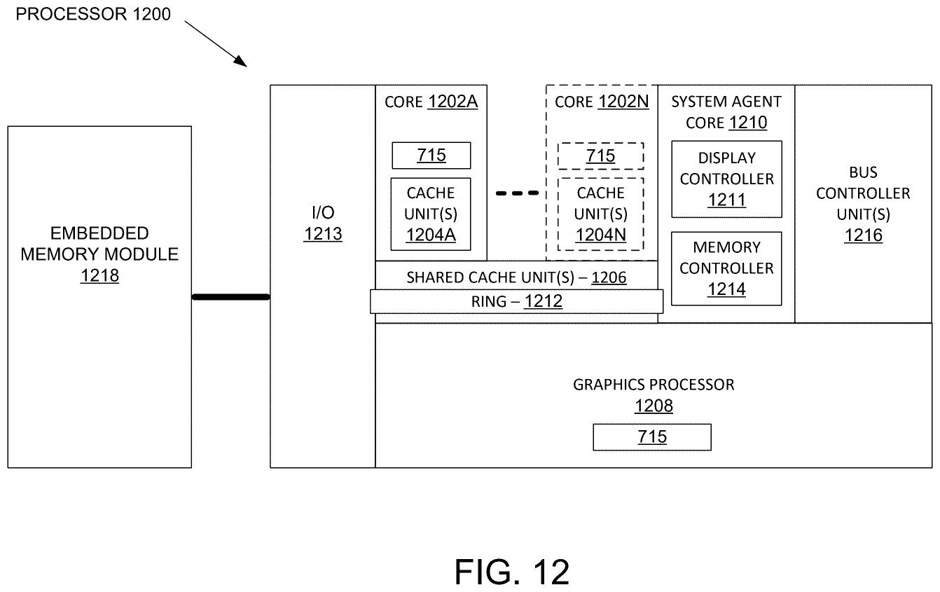

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached units 1206.

In at least one embodiment, internal cache unit(s) 1204A-1204N and shared cache units 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to render objects of different types, determine consistent secondary lighting effects for those objects, then composite the objects using the secondary lighting effects to generate composite images.

### Virtualized Computing Platform

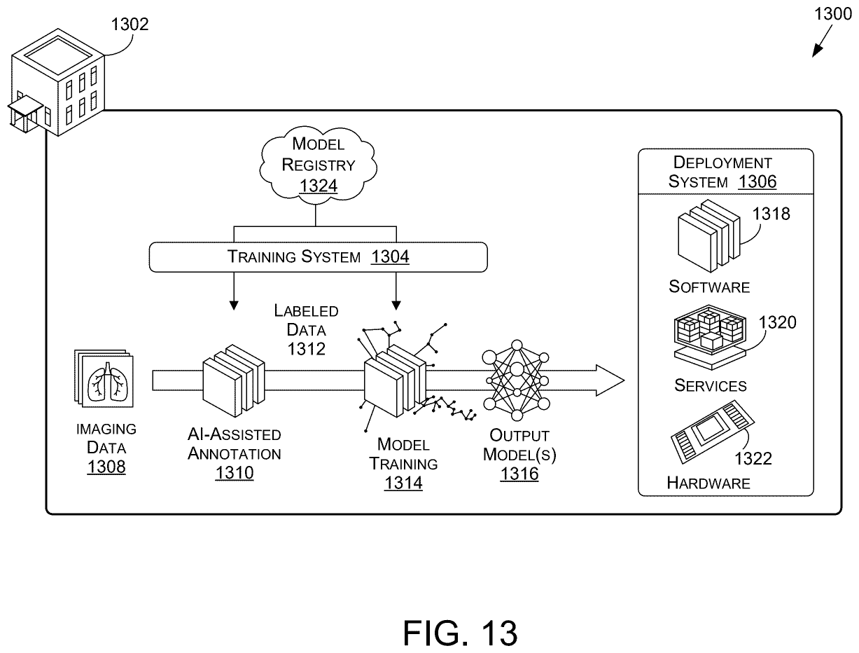

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

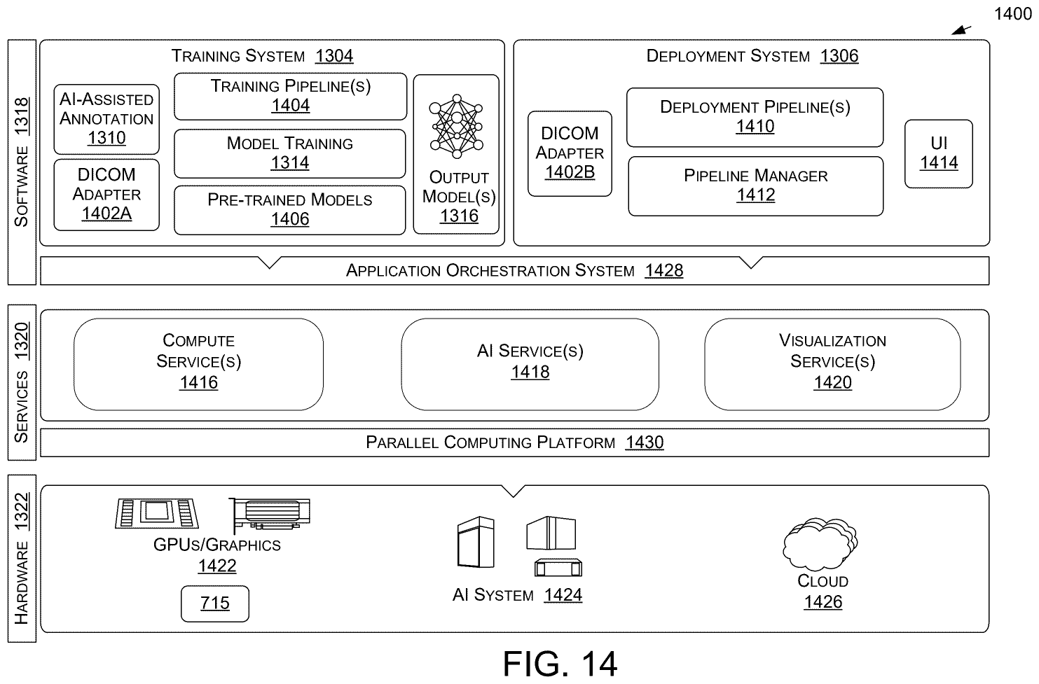

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

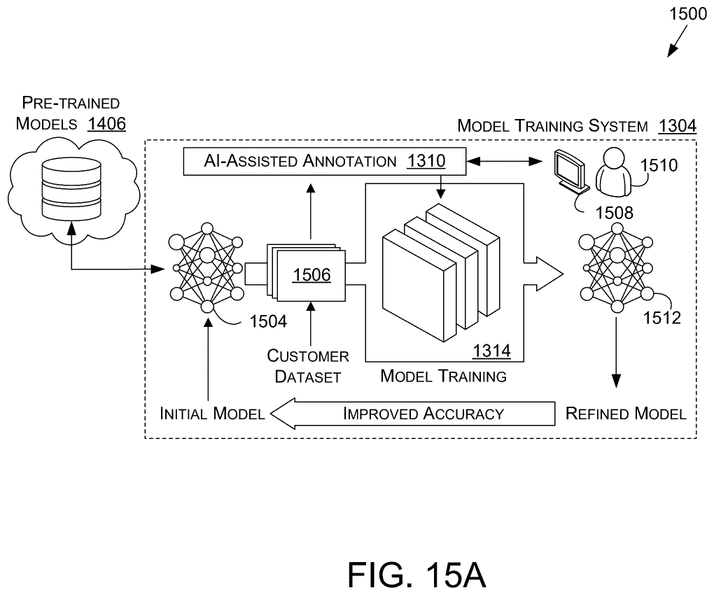

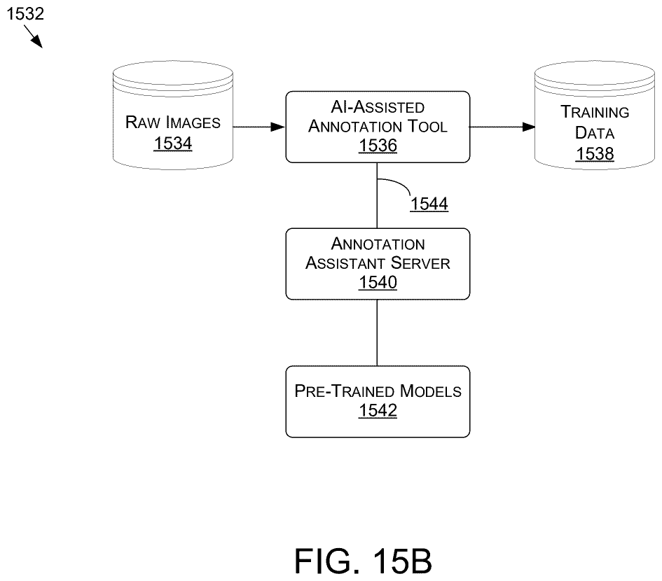

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1306 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto)annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:
1. A computer-implemented method, comprising:
generating a synthetic image including a virtual object inserted into a scene represented in an input image, the virtual object having one or more lighting effects applied according to one or more lighting parameters;
determining, using a machine learning model and according to a criterion, a measure of at least the one or more lighting effects associated with the virtual object in the scene as represented in the synthetic image;
updating the lighting parameters based in part on the measure; and
providing, for rendering one or more subsequent synthetic images for the scene including one or more virtual objects, a final set of lighting parameters in response to the measure of perceptual realism satisfying a threshold corresponding to the criterion.
2. The computer-implemented method of clause 1, wherein the synthetic image is generated using at least one of a differentiable renderer or a generative neural network.
3. The computer-implemented method of clause 1, wherein the machine learning model is a diffusion model, and wherein the measure is determined based at least in part upon a comparison of the synthetic image to a diffused image generated by the diffusion model receiving the synthetic image as input.
4. The computer-implemented method of clause 1, wherein the machine learning model includes a discriminator, and wherein the measure is provided as output of the discriminator based in part on processing the synthetic image.
5. The computer-implemented method of clause 1, wherein the lighting parameters are determined and updated using at least one of an environmental map, a spherical Gaussian, or a neural radiance model.
6. The computer-implemented method of clause 5, wherein the neural network is further used to generate the synthetic image.
7. The computer-implemented method of clause 1, wherein the lighting effects include at least one of: one or more shadows, one or more reflections, one or more refractions, one or more diffractions, one or more material properties, or one or more camera properties.
8. The computer-implemented method of clause 1, further comprising:
generating one or more additional synthetic images to provide as input to the machine learning model, and
updating based in part on one or more loss values output by the machine learning model, the updated lighting parameters until the measure is determined to at least satisfy the realism threshold.
9. The computer-implemented method of clause 1, wherein the machine learning model is trained to perform physics-based rendering, and further updated using training data for a plurality of lighting effects applied to a plurality of objects in a plurality of environments.
10. A processor, comprising:
one or more circuits to:
   generate a synthetic image using a generative model and based on lighting parameters associated with a virtual object to be inserted in an input image of a scene;
   process the synthetic image using a machine learning model to determine a loss value with respect to the synthetic image;
   update one or more of the lighting parameters; and
   generate an updated synthetic image using the generative model based at least in part on the determined loss value and the one or more updated lighting parameters.
11. The processor of clause 10, wherein the one or more circuits are further to:
calculate the loss value using a discriminator network receiving the synthetic image as input.
12. The processor of clause 10, wherein the one or more circuits are further to:
calculate the loss value in part by comparing a reconstructed image, generated by a diffusion model receiving the synthetic image as input, with the synthetic image.
13. The processor of clause 10, wherein the one or more circuits are further to:
generate additional synthetic images and update the lighting parameters until at least one criterion threshold is reached.
14. The processor of clause 10, wherein the lighting parameters are updated in part by adjusting one or more network parameters of the generative model, wherein the generative model is fine-tuned for the scene.
15. The processor of clause 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more large language models (LLMs);
a system implemented using one or more vision language model (VLMs);
a collaborative content creation platform for 3D assets; or
a system implemented at least partially using cloud computing resources.
16. A system, comprising:
one or more processors to determine a set of lighting parameters for a scene represented in an input image by, in part, generating a sequence of synthetic images including at least one virtual object inserted into the input image with lighting effects being applied according to a sequence of updated lighting parameters until at least one synthetic image of the sequence satisfies a criterion, wherein the updated lighting parameters are iteratively updated based in part upon loss values determined by a machine learning model processing the sequence of synthetic images.
17. The system of clause 16, wherein the machine learning model is a discriminator model receiving the sequence of synthetic images as input and inferring a probability of realism to be used to calculate the loss values.
18. The system of clause 16, wherein the loss values are calculated in part by comparing reconstructed images, generated by a diffusion model receiving the synthetic images as input, with the corresponding synthetic images.
19. The system of clause 16, wherein the set of lighting parameters are provided as input to a generative model to generate the synthetic images, or learned by the generative model.
20. The system of clause 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations;
a system implemented using one or more large language models (LLMs);
a system implemented using one or more vision language models (VLMs);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
generating a synthetic image including a virtual object inserted into a scene represented in an input image, the virtual object having one or more lighting effects applied according to one or more lighting parameters;
determining, using a machine learning model and according to a criterion, a measure of at least the one or more lighting effects associated with the virtual object in the scene as represented in the synthetic image;
updating the lighting parameters based in part on the measure; and
providing, for rendering one or more subsequent synthetic images for the scene including one or more virtual objects, a final set of lighting parameters in response to the measure of perceptual realism satisfying a threshold corresponding to the criterion.

2. The computer-implemented method of claim 1, wherein the synthetic image is generated using at least one of a differentiable renderer or a generative neural network.

3. The computer-implemented method of claim 1, wherein the machine learning model is a diffusion model, and wherein the measure is determined based at least in part upon a comparison of the synthetic image to a diffused image generated by the diffusion model receiving the synthetic image as input.

4. The computer-implemented method of claim 1, wherein the machine learning model includes a discriminator, and wherein the measure is provided as output of the discriminator based in part on processing the synthetic image.

5. The computer-implemented method of claim 1, wherein the lighting parameters are determined and updated using at least one of an environmental map, a spherical Gaussian, or a neural radiance model.

6. The computer-implemented method of claim 5, wherein the neural network is further used to generate the synthetic image.

7. The computer-implemented method of claim 1, wherein the lighting effects include at least one of: one or more shadows, one or more reflections, one or more refractions, one or more diffractions, one or more material properties, or one or more camera properties.

8. The computer-implemented method of claim 1, further comprising:
generating one or more additional synthetic images to provide as input to the machine learning model, and
updating based in part on one or more loss values output by the machine learning model, the updated lighting parameters until the measure is determined to at least satisfy the realism threshold.

9. The computer-implemented method of claim 1, wherein the machine learning model is trained to perform physics-based rendering, and further updated using training data for a plurality of lighting effects applied to a plurality of objects in a plurality of environments.

10. A processor, comprising:
one or more circuits to:
generate a synthetic image using a generative model and based on lighting parameters associated with a virtual object to be inserted in an input image of a scene;
process the synthetic image using a machine learning model to determine a loss value with respect to the synthetic image;
update one or more of the lighting parameters; and
generate an updated synthetic image using the generative model based at least in part on the determined loss value and the one or more updated lighting parameters.

11. The processor of claim 10, wherein the one or more circuits are further to:
calculate the loss value using a discriminator network receiving the synthetic image as input.

12. The processor of claim 10, wherein the one or more circuits are further to:
calculate the loss value in part by comparing a reconstructed image, generated by a diffusion model receiving the synthetic image as input, with the synthetic image.

13. The processor of claim 10, wherein the one or more circuits are further to:
generate additional synthetic images and update the lighting parameters until at least one criterion threshold is reached.

14. The processor of claim 10, wherein the lighting parameters are updated in part by adjusting one or more network parameters of the generative model, wherein the generative model is fine-tuned for the scene.

15. The processor of claim 10, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations;
a system implemented using one or more large language models (LLMs);
a system implemented using one or more vision language model (VLMs);
a collaborative content creation platform for 3D assets; or
a system implemented at least partially using cloud computing resources.

16. A system, comprising:
one or more processors to determine a set of lighting parameters for a scene represented in an input image by, in part, generating a sequence of synthetic images including at least one virtual object inserted into the input image with lighting effects being applied according to a sequence of updated lighting parameters until at least one synthetic image of the sequence satisfies a criterion, wherein the updated lighting parameters are iteratively updated based in part upon loss values determined by a machine learning model processing the sequence of synthetic images.

17. The system of claim 16, wherein the machine learning model is a discriminator model receiving the sequence of synthetic images as input and inferring a probability of realism to be used to calculate the loss values.

18. The system of claim 16, wherein the loss values are calculated in part by comparing reconstructed images, generated by a diffusion model receiving the synthetic images as input, with the corresponding synthetic images.

19. The system of claim 16, wherein the set of lighting parameters are provided as input to a generative model to generate the synthetic images, or learned by the generative model.

20. The system of claim 16, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations;
a system implemented using one or more large language models (LLMs);
a system implemented using one or more vision language models (VLMs);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.
